(19) United States
(12) Patent Application Publication
(10) Pub. No.: US 2010/0274651 A1
(43) Pub. Date: Oct. 28, 2010

(54) APPLICATION ENABLING A SHORT MESSAGE SERVICE (SMS) MESSAGE WITH AN ADVERTISEMENT TO BE SENT FROM THE MOBILE PHONE DEVICE USING A PULL-AND-PUSH METHOD

(76) Inventor: Marcus L. Huddleston, Inglewood, CA (US)

Correspondence Address: Marcus L. Huddleston, 3690 W. Scribner Lane, Inglewood, CA, 90305, US

(21) Appl. No.: 12/768,489

(22) Filed: Apr. 27, 2010

Related U.S. Application Data
(60) Provisional application No. 61/173,314, filed on Apr. 28, 2009.

(51) Int. Cl. G06Q 30/00; H04L 12/58; H04W 4/00

(52) U.S. Cl. 705/14.16; 455/412.1; 455/466

(57) ABSTRACT

A method of SMS message advertising using an mobile device application, the method includes providing the application the ability to download at least one advertisement, giving a sender the choice to select the advertisement to be attached to a SMS message, and then account for the advertisement sent by the sender so that a credit is applied to the sender.

### CROSS-REFERENCE TO RELATED APPLICATIONS

This application claims the benefit of U.S. Provisional patent application No. 61/173,314, filed Apr. 28, 2009, herein incorporated by reference.

### BACKGROUND OF THE INVENTION

The present invention generally relates to relates a software application and method of mobile device advertising, and, more specifically, to an software application stored on a mobile device that enables a Short Message Service (SMS) messages with an advertisement to be sent from the mobile device using a pull-and-push method.

Known methods of advertising via SMS messages include automatically inserting an advertisement into a sender's text message after the sender sends the message. In currently known methods of sending advertisements via SMS messages, a sender does not know what advertisement will be sent, because random messages are used.

As can be seen, there is a need for advertising via SMS messages wherein the sender is aware or which advertisements are being sent.

### SUMMARY OF THE INVENTION

In one aspect of the present invention, a method of SMS message advertising using a mobile device application comprises providing the application the ability to download at least one advertisement; giving a sender the choice to select the advertisement to be attached to a SMS message; accounting for the advertisement sent by the sender; and crediting the sender.

In another aspect of the present invention, a method for sending a SMS advertisement to a mobile device user recipient comprises equipping a sender's mobile device with an application to receive and update advertisements from an advertisement management system; allowing a sender to select the advertisement to send to the mobile device user recipient; and rewarding the sender for sending the advertisement.

These and other features, aspects and advantages of the present invention will become better understood with reference to the following drawings, description and claims.

### BRIEF DESCRIPTION OF THE DRAWINGS

FIG. 1 is a flow chart describing an advertising method according to an exemplary embodiment of the present invention;

FIG. 2 is a continuation of the flow chart of FIG. 1; and

FIG. 3 is a flow chart describing an advertising method according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a unique way for consumers to send SMS messages to a recipient along with an advertisement, and receive credit for sending such advertisement. By allowing the sender the ability to choose the advertisement they would like to send, a sender can select those advertisements they feel the most comfortable with sending, and those they identify with or feel are the most pertinent to the person who will be receiving the message. This application of the present invention puts the control of sending advertisements through the use of SMS messages in the hands of the sender, avoiding embarrassment, and improving targeted advertising.

The advertisement SMS application provides a new media platform to send and display advertisements to mobile device users. Applicable mobile devices can include, but are not limited to, mobile phones, PDAs, and other mobile texting/emailing devices. Since an SMS message is still widely used as a pure data application, the impact of advertisement as part of normal SMS messages can generate significant revenue for mobile operators, application providers, and consumers. At the same time, it can provide a great channel for advertisers to capture mobile phone users. Hereinafter, a sender is defined as the user of the mobile phone, the ordinary consumer who uses a mobile device.

In one aspect of the present invention, the sender may choose which advertisement to send from a list of advertisements presented to them, before giving the sender the ability to type a text message, and/or before sending their SMS message. Users can also change the advertisement they pick once in the texting mode of the application or before they click send.

In another embodiment of the invention, a service is provided that may allows for a sender to be paid/credited for choosing to send an advertisement with his/her SMS message.

For ease of illustration, a mobile phone will be used in the examples throughout this application. It should be noted that other mobile devices are also contemplated.

In yet another embodiment, the sender may selectively send advertisements with their SMS messages and make money from sending the advertisements. Sending an advertisement can or cannot be a pre-requisite to sending a regular SMS message.

In another embodiment, an application for performing the methods of the present invention may be an on-deck application stored on the sender's mobile phone device, and may be dedicated for the purpose of sending advertisement SMS messages.

In another embodiment, the advertisement from the mobile device may be attached at the bottom of the SMS message when the users start an SMS message, as opposed to the advertisement being inserted into the message after the message is sent.

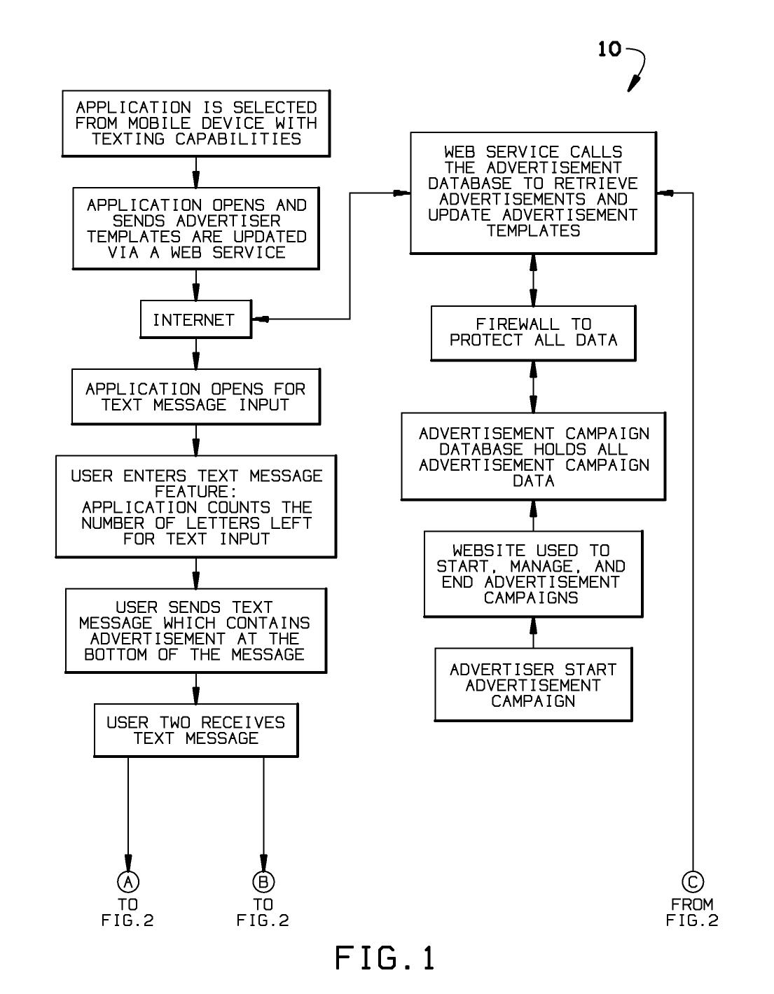

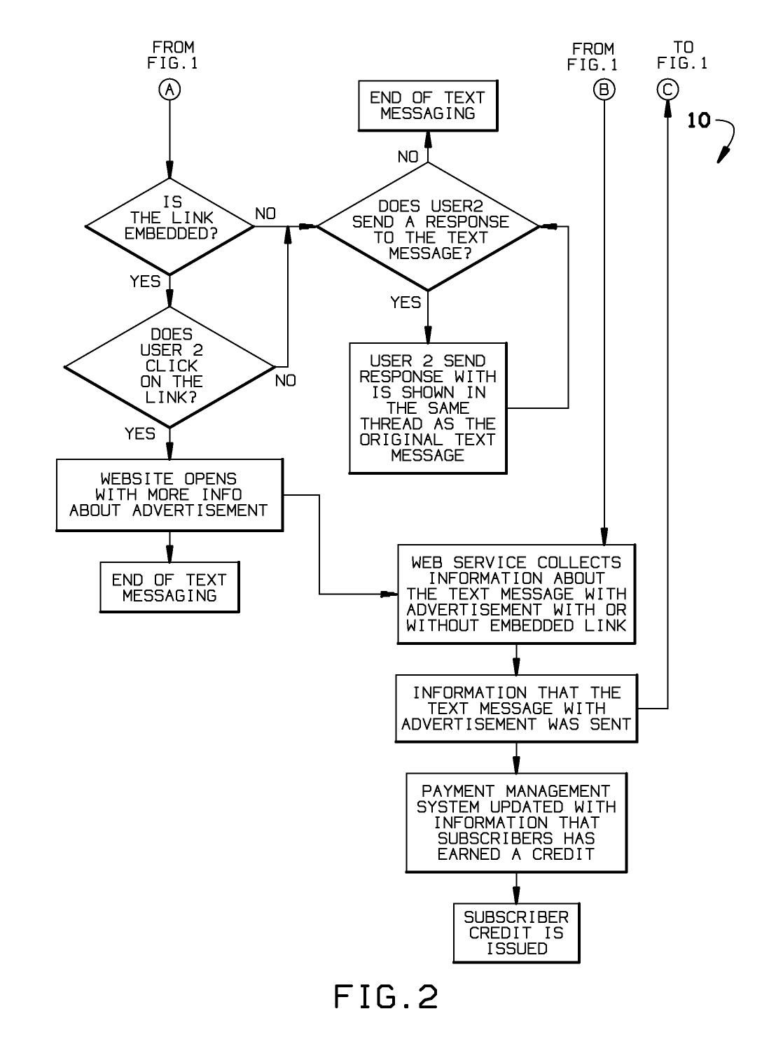

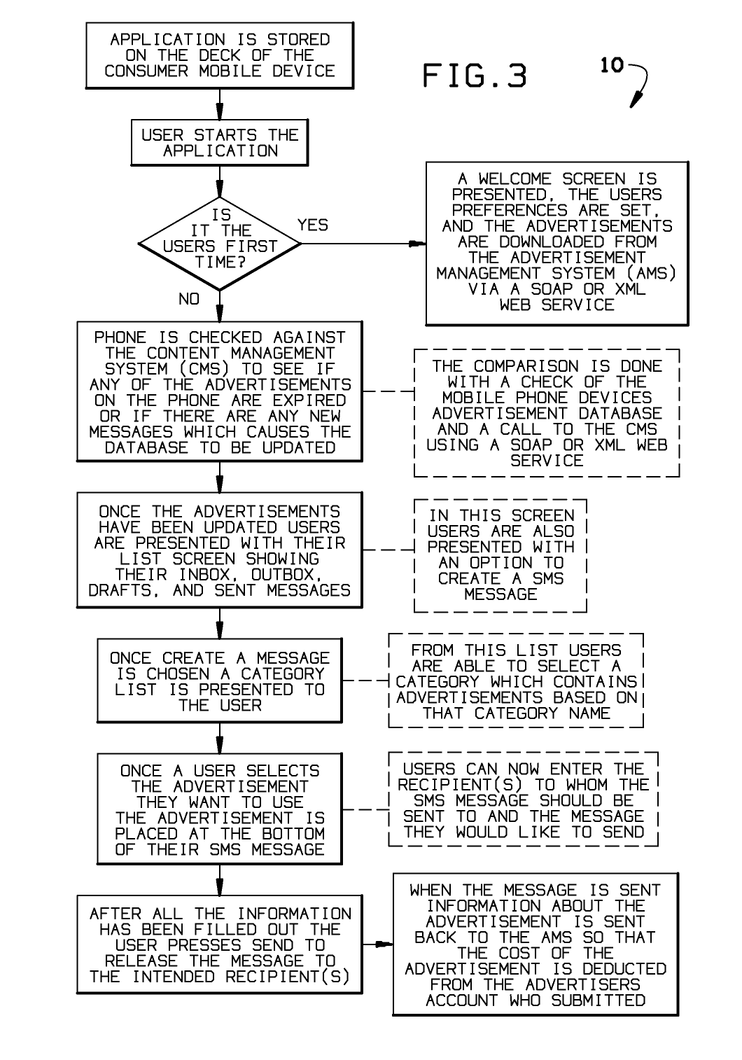

Referring to FIGS. 1-3, according to a method 10 of the present invention, in operation, the sender may start the application. The application may be stored on the deck of the mobile device. If it is the first time accessing the application, a welcome screen may be presented, the sender's preferences may be set, and the advertisements may be download from the advertisement management system (AMS) via a simple object access protocol (SOAP), an extensible markup language (XML), or binary web service.

If it is not the sender's first time using the application, the mobile device may be checked against a content management system (CMS) to see if any of the advertisements on the phone are expired or if there are any new messages which causes the database to be updated. The comparison may be done with a check of the mobile phone devices advertisement database and a call to the CMS using a SOAP, XML, or binary web service.

After the advertisements have been downloaded and/or updated to the mobile device, the sender may be presented with a message list screen showing his/her inbox (used for incoming SMS messages), outbox (used for outgoing SMS message), a draft Messages box (used for storing unsent SMS messages), and sent box (used for sent SMS messages). In this screen the sender may be presented with an option to create a SMS message.

Once the “create a message” is chosen a category list may be presented to the sender. From this list, a sender can select a category which contains advertisements based on that category name. Once a sender selects the advertisement he/she wants to use, the advertisement may be placed at the bottom of their SMS message. The sender can now enter the recipient(s) to whom the SMS message should be sent to, and enter the message he/she would like to send to the recipient(s). After all the information has been filled out the sender may press send to release the message to the intended recipient(s).

It should be understood, of course, that the foregoing relates to exemplary embodiments of the invention and that modifications may be made without departing from the spirit and scope of the invention as set forth in the following claims.

We claim:

1. A method of SMS message advertising using a mobile device application, the method comprising:
providing the application the ability to download at least one advertisement;
giving a sender the choice to select the advertisement to be attached to a SMS message;
accounting for the advertisement sent by the sender; and
crediting the sender.

2. The method of claim 1, further comprising choosing which advertisement to send from a list of advertisements before giving the sender the ability to type a text message.

3. The method of claim 1, wherein the application is an on-deck application stored on the sender's mobile phone device, dedicated for the purpose of sending advertisement SMS messages.

4. The method of claim 1, further comprising attaching the advertisement at the bottom of the SMS message when the users start the SMS message.

5. The method of claim 1, further comprising downloading advertisements from an advertisement management system (AMS) via a simple object access protocol (SOAP), an extensible markup language (XML), or binary web service.

6. The method of claim 1, further comprising updating the advertisements on the mobile device.

7. The method of claim 1, further comprising sending the information about the advertisement being sent back to an advertisement management system so that the cost of the advertisement is deducted from an advertiser's account.

8. The method of claim 1, wherein, when the advertisement contains an embedded link, the sender is credited when a recipient of the advertisement clicks on the embedded link.

9. A method for sending a SMS advertisement to a mobile device user recipient, the method comprising:
equipping a sender's mobile device with an application to receive and update advertisements from an advertisement management system;
allowing a sender to select the advertisement to send to the mobile device user recipient; and
rewarding the sender for sending the advertisement.

10. The method of claim 9, further comprising either a) choosing which advertisement to send from a list of advertisements before giving the sender the ability to type a text message, or b) allowing the user to type the text message and optionally insert the advertisement before sending the text message.
